(19) United States
(12) Patent Application Publication
(10) Pub. No.: US 2017/0124914 A1
(43) Pub. Date: May 4, 2017

(54) UV CURING VISUALIZER SYSTEM AND PROCESS

(71) Applicant: SPDI, Inc., Delray Beach, FL (US)

(72) Inventors: John Wilson, Boynton Beach, FL (US); Robert Schenk, Lakeworth, FL (US)

(21) Appl. No.: 15/341,872

(22) Filed: Nov. 2, 2016

Related U.S. Application Data
(60) Provisional application No. 62/249,939, filed on Nov. 2, 2015.

(51) Int. Cl. G09B 19/24

(52) U.S. Cl. CPC G09B 19/24

(57) ABSTRACT

A UV curing training aid and method that includes a substrate, a plurality of UV photochromatic labels that have been exposed with a predetermined dosage of UV radiation and to a predetermined exposure color and that have been placed on the substrate, a plurality of UV photochromatic labels that have not been exposed with UV radiation, have a predetermined color and have been placed on the substrate, and a thermometer, whereby upon simulating the curing of a UV curable coating on the substrate, an operator of a UV irradiator can train to cure a UV curable substrate by moving the UV radiator across the substrate at a rate of speed and at a height above the substrate to cause the unexposed labels to turn color to match or correspond to the predetermined exposure color of the previously exposed label.

### CROSS REFERENCE TO RELATED APPLICATIONS

This application claims priority to U.S. Provisional Application No. 62/249,939 dated Nov. 2, 2015.

### FIELD OF INVENTION

The disclosure relates generally to UV curing of surfaces that have UV curable coating and, in particular as an aid for using a hand-held UV irradiator to cure the coated surfaces. More particularly, the systems and methods described herein are used in repair of automotive body parts, generally described, for example, in U.S. Pat. No. 9,035,271, and U.S. Pat. No. 9,099,213. The system can also be used as a aid to determining when the UV lamp in the irradiator no longer outputs sufficient UV energy to be useful and therefor when the UV lamp should be replaced.

### BACKGROUND

Mobile radiation systems and of methods of curing radiation curable coating compositions are well known, particularly in the field of collision and cosmetic repair of body parts of vehicles such as cars and trucks. Typically in this field, a primer coating formed of a radiation curable composition is placed on a substrate, typically a body part of a vehicle such as a car or truck, and the coated substrate is then exposed to a dosage of UVA and UVB radiation sufficient to cure, set or dry the coated surface. Typically, when a hand-held irradiator is used, the operator, or user, positions the irradiator at some distance from the coated surface and then moves the irradiator back and forth across the coated surface so that the coated surface is exposed to radiation from the UV lamp of the irradiator. Also, typically, the UV lamp will be positioned in a housing that includes a reflector, and the UV radiation will be concentrated along a line that is at a predetermined distance away from the longitudinal centerline of the UV lamp. Proper curing is achieved when the proper amount, or dosage, of UV radiation is uniformly applied to the uncured, coated surface or substrate.

Conventional devices typically require a combination of a radiation curable coating such as a primer, a radiation source or a radiator and a power supply. Typically, the user of such a handheld irradiator reciprocates the UV irradiator over the freshly coated surface. The UV irradiator emits electromagnetic energy in both the visible and as well as invisible (UVA and UVB) ranges of the spectrum. Because the UV radiation emanating from the irradiator is not visible, it is not possible for the user to accurately determine whether the dosage being applied to the coated surface is optimum, or in some instances, whether it is even sufficient or effective to properly cure the coated surface. While it is known to use expensive, relatively delicate, laboratory type equipment, such as for example, a radiometer, to measure the UV radiation emitted from a UV lamp, such expensive equipment is not practical for high volume, industrial environment car repair uses.

Numerous problems can result from an improper curing method, with such problems resulting in a poor result and showing up within 24 hours of the curing process or even sooner. Typical problems resulting from improper curing method and/or inadequate UV radiation emitted from the UV lamp include, for instance, the coating peeling off (adhesion loss), the coating having blemishes, failure to bond with additional coatings on top of the primer. Typical sources of improper curing are use of a worn, deteriorated, or damaged UV lamp that no longer provides sufficient power or, more commonly, user error including lack of applying the proper dosage to the coated surface because the user is moving the irradiator too quickly over the surface and/or too far away from the surface.

At present there is no known training aid or device that, as a practical matter, can be used for training a user of a handheld UV curing device to properly cure a coated surface. Furthermore, there is no known aid or device that, as a practical matter can assist the user to determine whether a UV lamp is emitting sufficient UV radiation to effectively cure coated surfaces.

### SUMMARY OF THE INVENTION

The training aid and UV lamp power level indicator according to the present invention provides, for the first time known, an aid that can be used to train people on how to successfully cure a radiation curable coating with a hand-held irradiator. The preferred UV curing training aid includes a substrate, a plurality of UV photochromatic labels that have been exposed with a predetermined dosage of UV radiation and to a predetermined exposure color and that have been placed on the substrate; a plurality of UV photochromatic labels that have at least initially not been exposed with UV radiation, have a predetermined color and have been placed on the substrate adjacent the previously exposed labels, and a thermometer, whereby upon simulating the curing of a UV curable coating on said substrate, an operator of a UV irradiator can train himself to cure a UV curable substrate by moving the UV radiator across the substrate at a rate of speed and at a height above or distance from the substrate to cause the unexposed labels to turn color to match or correspond to the predetermined exposure color of the previously exposed labels.

These and other embodiments, features, aspects, and advantages of the invention will become better understood with regard to the following description, appended claims and accompanying drawings.

### BRIEF DESCRIPTION OF THE DRAWINGS

The foregoing aspects and the attendant advantages of the present invention will become more readily appreciated by reference to the following detailed description, when taken in conjunction with the accompanying drawings, wherein:

FIG. 1 is a top, schematic view of a preferred embodiment of the UV curing method training aid;

FIG. 2 is a schematic representation of a UV lamp including its lamp holder for use with the FIG. 1 training aid;

FIG. 3 is an illustration of training aid strips used in an alternate environment of use, as compared to the environment of use of the FIG. 1 embodiment;

FIG. 4 is a view of the strips of the training aid used in a different environment of use from those shown in FIGS. 1 and 3;

FIG. 5 is a drawing illustrating the relative degree of delivered UV intensity as measured from the center line of the UV lamp and as related to the present UV training aid;

FIG. 6 is a top view of the outer periphery of the FIG. 3 embodiment, in the region of location of the UV sensitive strips;

FIG. 7A is a schematic top view of a UV training guide map.

FIG. 7B is a schematic top view of another embodiment of a UV training guide map; and

FIG. 7C is a schematic top view of another embodiment of a UV training guide map.

Reference symbols or names are used in the figures to indicate certain components, aspects or features shown therein. Reference symbols common to more than one Figure indicate like components, aspects or features shown therein.

### DETAILED DESCRIPTION

For the purposes of promoting an understanding of the principles of this disclosure, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc. Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional un-recited elements or method steps.

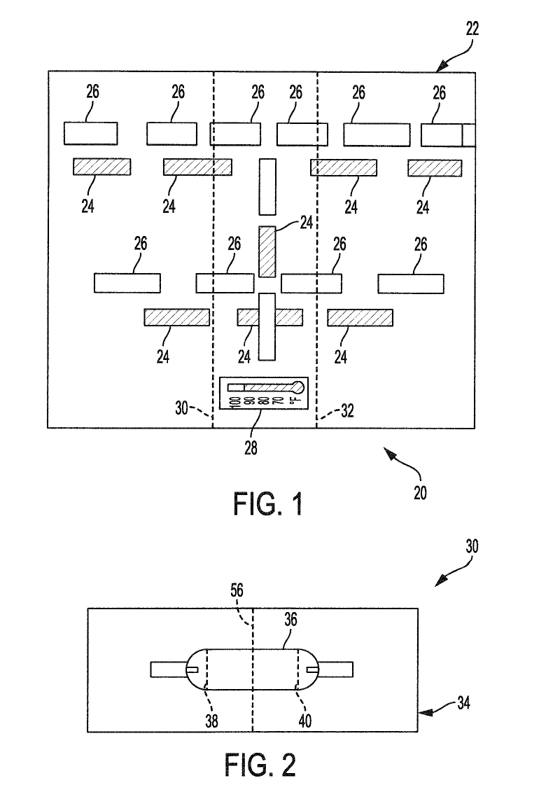

Referring to FIG. 2, a schematic representation of a UV irradiator 30 comprises a lamp housing 34 and a UV lamp 36 is shown. The UV irradiator 30 has a longitudinal centerline 56 between a first electrode approximately at the vertical dash line 38 and a second electrode approximately at vertical dash line 40. With reference to FIGS. 1 and FIG. 2 the dash lines 38 and 40 of FIG. 1 are shown with the left side dash line 38 of FIG. 1 corresponding to the left side dash line 30 of FIG. 2, and the right side dash line 40 of FIG. 1 corresponding to the right side dash line 32 of FIG. 2. As further explained and described herein, the area in between the left dash line 30 and right dash line 32 of FIG. 1 represents the path or area of optimum intensity or optimum delivery of UV radiation to the surface or substrate 22 as the lamp 36, when energized, is moved over the surface of substrate 22.

FIG. 1 is a top, schematic view of on embodiment of UV curing training aid 20. The aid comprises a substrate, or bottom layer 22, which may be made of paper or other durable, radiation resistant material. UV cured reference labels 24 are placed at predetermined locations on the surface of substrate 22. The UV cured reference labels 24 are photochromatic labels that have been exposed to a UV dosage that is known to be a successful as an optimum dosage for a particular use, such as for curing the primer coating, color coating clear coating or other coating on an automobile body part being repaired. The UV cured reference labels 24 will exhibit a certain degree of color or color intensity that corresponds to a total, optimum UV dosage for the particular application or desired use. The pre-exposed UV cured reference labels 24 are commercially available from UV Process Supply, Inc., Chicago, Ill., 60614 as its Part No. N010-005, also known as “New UV Intensity Labels”.

A set of unexposed UV labels 26 are positioned at other predetermined locations on the substrate 22. In some embodiment, the labels 26 are disposed adjacent to one or more cured UV labels 24 in a grid-like pattern. The unexposed UV labels 26 are the same type of photochromatic labels as UV cured reference labels 24, but have not been exposed to UV radiation. In some embodiments, the unexposed labels will have a yellow color. As the unexposed UV labels 26 are exposed to UV, the color of the label will gradually change from a first color to a second color. For example, in one embodiment, the unexposed UV labels 26 change from yellow into green, deeper shades of green and then to blue which is the maximum exposure color. The number of labels 24 and 26 can vary, and the placement on a surface can vary. In some embodiments, the labels 24 and 26 are removably attached to the substrate 22, such as by an adhesive. In some embodiments, the labels 24 and 26 themselves are adhesive backed. In other embodiments, the labels 24 and 26 are permanently attachable to a substrate 22, if desired.

The unexposed UV labels 26 function to measure specific UV dosage by changing color based on the total amount of UV energy received. Labels 26 are known as photochromatic labels and they indicate the accumulated UV light dosage to which they have been subjected. They can be used to determine the level of UV dosage with a simple, visual inspection of the color change, and are therefore advantageous because they are able to provide useful information about the UV radiation dosage, which is not visible to the human eye, in a form that is visible to the human eye. As noted above, upon exposure to UV light, these initially unexposed UV labels 26 begin to change color upon receiving the UV dose. For example, the labels begin as a bright yellow and turn to a deep blue as the dosage is increased. Labels 26 are adapted for a wide range of UV doses, for example from 0 mJ/cm² to greater than 5,000 mJ(5J)/cm² and therefore, in some embodiments, may be considered “high intensity.” Because they are thin and have flexibility they can be used in virtually all applications where use of a radiometer is not possible. They are well-suited for exposure training and lamp power output verification in the automotive repair and reconstruction field.

In some embodiments, a thermometer 28 is disposed on the surface of the substrate 22. The thermometer functions as an additional aid, by providing a visual indication that, in a general sense, correlates with the UV power that is delivered to the substrate from the UV lamp. The UV radiation delivered to the substrate degenerates to heat, and thus the UV radiation is a heat source to the substrate. As heat is generated, the temperature rises. In a new, fully operational UV irradiator 30, during typical curing in the automotive body repair field, temperatures in the range of 95-105° would be considered normal, based on an ambient of about 70°. If, during use of the training aid the temperature failed to rise above 90°, it is likely that the UV lamp is worn out, does not provide sufficient UV dosage and should be replaced. Thus, the UV curing training aid as described herein also may be used to determine usefulness of the UV lamp, and whether it should be replaced due to inadequate output power. Accordingly, when the thermometer does not rise above 90 degrees, this is a general warning or indication that the UV lamp is not performing satisfactorily and perhaps is near to its end of life. Also, a low temperature could indicate that the user is holding the lamp too far away from the substrate, or moving the lamp too quickly across the substrate during the curing method.

As noted above, in some embodiments the color of the labels change from a first color, for example yellow, in an unexposed condition, to the maximum exposure color, for example a dark blue/green color. When the UV irradiator 30 is moved over the substrate 22 for example in a centered position between the area between lines 30 and 32, greatest intensity, highest dosage and darkest color appears along the center line of the substrate 22. Thus, UV labels 26 nearest the center of the substrate will turn the darkest color. Moving away from the center of the substrate 22, it may be seen that the color of UV intensity labels 26 goes from a dark blue/green to yellow, representing the fact that a lower UV dosage has been applied to labels 26 that are further away from the center.

The present invention is configured for compatibility with conventional, commercially available handheld UV curing devices. For example, UV irradiator 30 may be a model 1100 UV irradiator which is a relatively small device with a relatively narrow curing path. UV irradiator 30 may be a larger model 2400 handheld curing device irradiator which has, correspondingly, a greater or wider curing path. Both the UV 1100 and the UV 2400 irradiators have parabolic reflectors in their housing, the line of highest intensity of UV radiation occurs at a distance of about 3 inches from the center line of the UV lamp 36 of each of the models 1100 and model 2400 irradiator. Accordingly, a movement or reciprocation of either the model 1100 or the model 2400 from left to right and right to left across the substrate 22, at a distance of approximately 3 inches, provides for optimum curing of a curable substrate coating placed on the substrate 22. By observing the change of color from yellow to the dark blue/green of the optimum exposed UV intensity labels 26, and by observing a temperature rise to approximately 95 to 105 degrees F. of thermometer 28, a person training in operation of a UV irradiator to perform UV curing will be able to train himself with the aid disclosed herein. These visual indicators assist the operator to learn the proper distance away from the substrate and the proper rate of speed of travel of the irradiator over the surface in order to achieve an optimum cure of the coating applied to the underlying substrate.

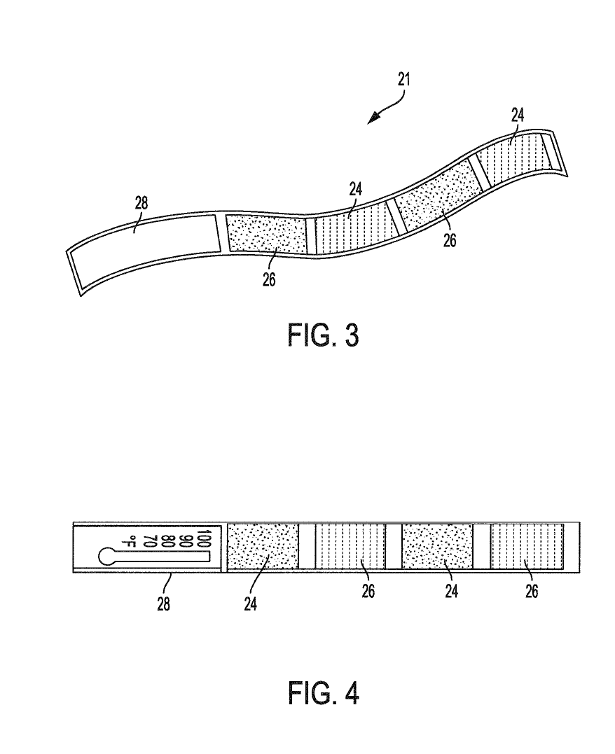

In addition to the training aid 20 discussed above, the present invention can be configured as an application strip 21. Referring to FIG. 3, a side, schematic view of the strip 21 of labels 24, 26 is shown. Referring to FIG. 4, a top, schematic view of the strip 21 includes a plurality of labels 24 and 26 and thermometer 28. In this embodiment, the strip can be removably applied to a desired target or substrate, such as an automotive part, guitar body or neck, or other surface on which a UV curable paint or other UV curable coating is desired. Accordingly, strip 21 may be adhesive back for easy application and use. This allows a user to train in UV curing application on an irregular surface or on the actual surface to be cured prior to application of the uncured paint in order to gain an understanding of the particular UV curing application principals required for a specific job, component, part, or schema.

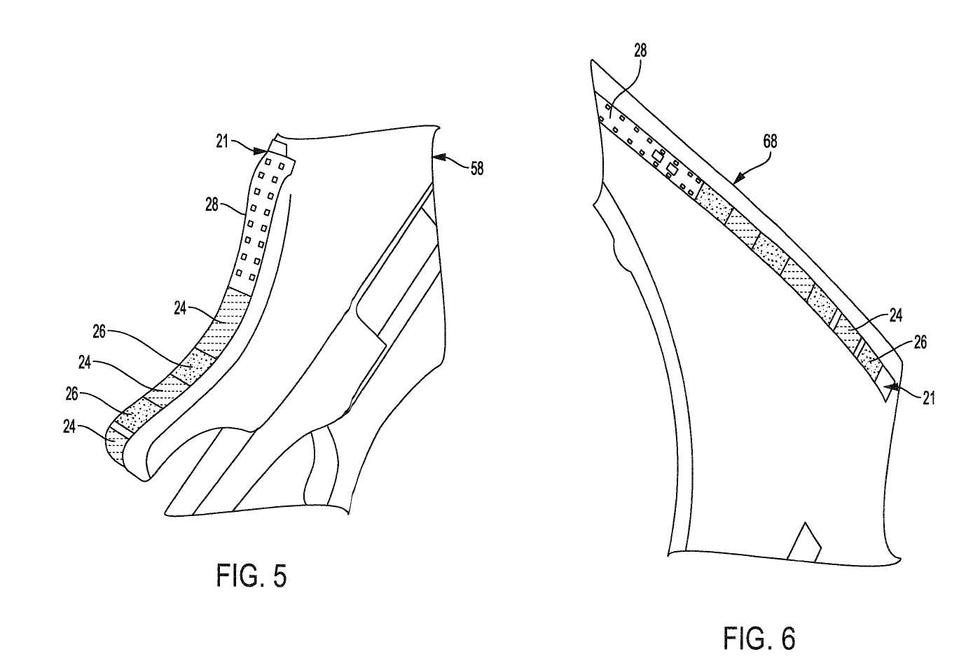

Referring to FIG. 5, a guitar body 58, having a curved edge is shown with applied strip 21 of the present invention. Guitars of this type typically have a radiation curable coating on the outer surface including the top surface, the rear surface and the side curved surfaces. Proper curing of the curved surfaces has proven to be very difficult under normal, conventional conditions. As shown in FIG. 5 strip 21 containing a series of UV cured reference labels 24 and unexposed UV labels 26 has been placed on a curved surface of guitar body 58. The strip 21 may be adhesive in order to attach cohesively with the surface of the target object. In use, the operator or user would typically train to cure the surface by practicing a number of times, for example, 3 to 5 times, on the curved surface with the two types of intensity labels. Such practice will allow the user to accomplish a goal of applying UV light with UV irradiator 30 to the labels and attempting to match the color of the unexposed UV labels 26 to the UV cured reference labels 24.

Referring to FIG. 6, an automobile fender 68 is shown as the substrate upon which a strip 21 of the UV cured reference labels 24 and unexposed UV labels 26 have been placed adjacent to each other in successive fashion to aid in training an operator. During training of the user, the user would move the irradiator back and forth over the substrate 22, 58, 68 and would observe changing color of the unexposed UV labels 26 as the UV irradiator 30 is moved back and forth along the substrate (as shown in FIG. 6, fender 68 and in FIG. 5, guitar body 58). In some embodiments, the unexposed UV labels 26, which start out as a yellow color, become increasingly green as they are exposed to UV radiation and the total dosage to them increases to the desired dosage, which matches the UV cured reference labels 24. Also shown in FIGS. 5 and 6, it is desirable to include thermometer 28 positioned on the strip 21.

Also, as may be appreciated by the scale of this art, the UV labels 24 and 26, and thermometer 28 may be used to provide visual indication on whether the UV lamp 40 is maintaining its power level, or whether it is wearing, burning or dying out. Thus, at periodic or predetermined times a user could use a series of the strips 21 and/or the thermometer 28 to generate a rough measure the performance of the UV lamp. Specifically, if, as the lamp is being moved back and forth over the thermometer 28 and the temperature does not rise or rises only slightly, this indicates that, although visual energy or visual light might be emanating from the lamp 40, sufficient UV is not emanating from the lamp and insufficient UV energy is not being provided by the lamp 40 to the substrate. In additional to thermometer 28, failure of UV intensity labels 26 to change color to the deep blue/green color may indicated poor lamp performance or that the lamp should be replaced. Such poor lamp performance and possible lamp replacement may also be indicated when color change is very slow during irradiator reciprocation over the surface at about 3 inches therefrom.

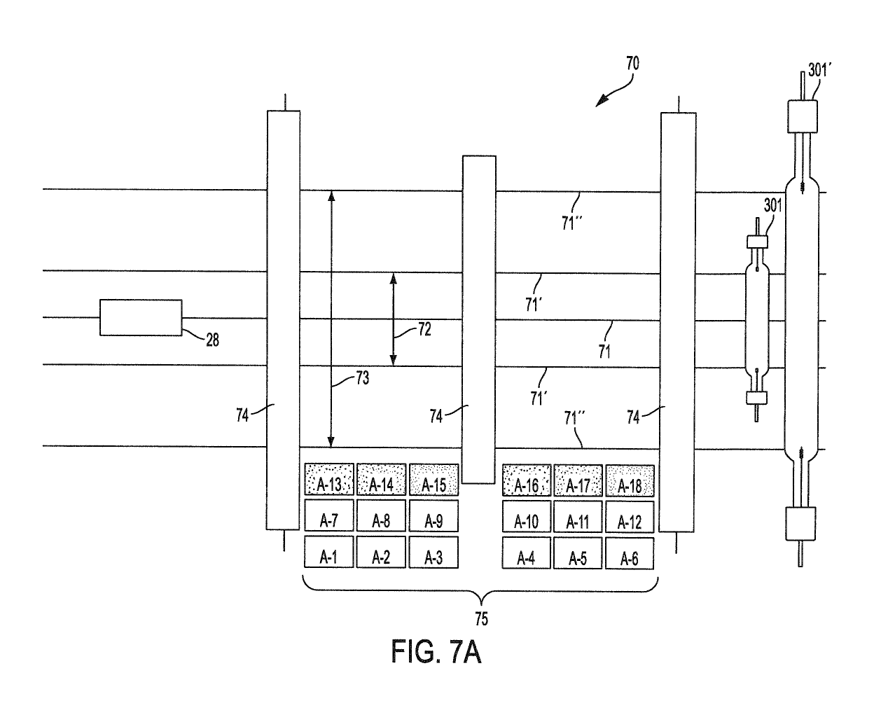

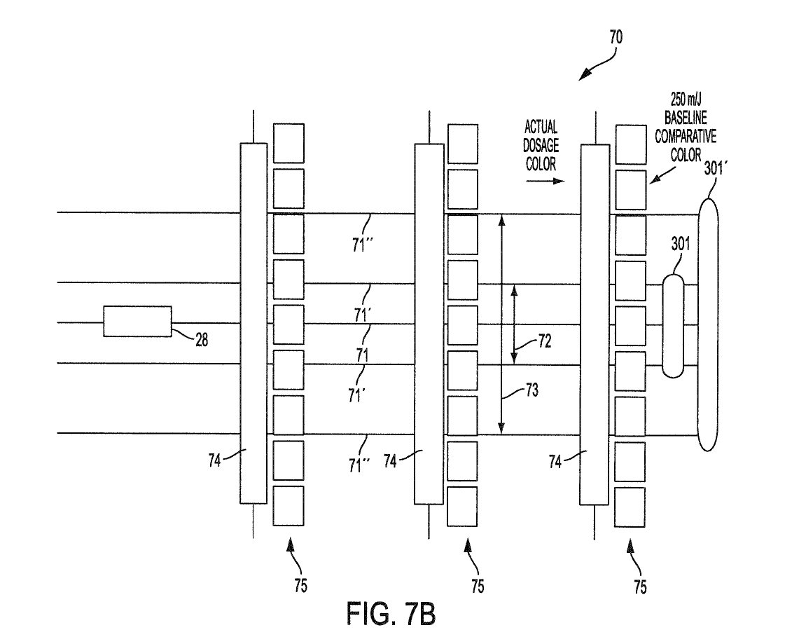

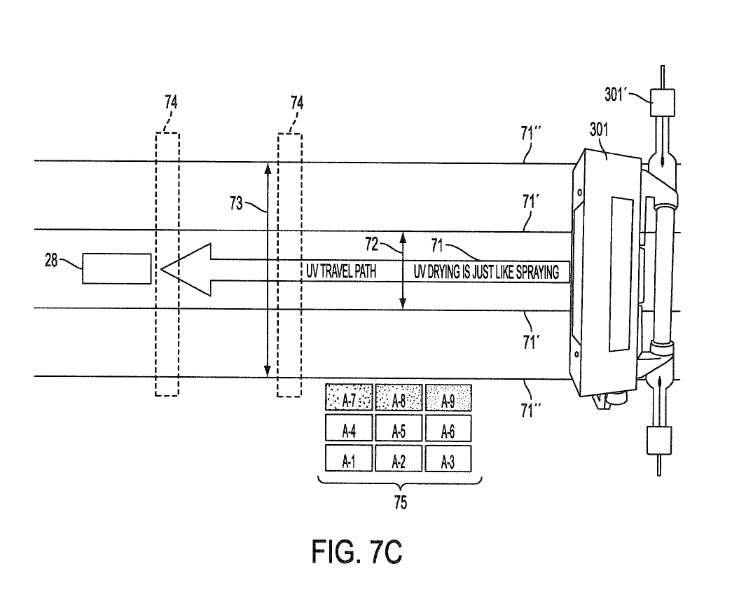

FIGS. 7A-7C depict alternative embodiments of the training aid 20 of the present invention configured as a training visualization guide map that includes a plurality of designations to aid in training. FIGS. 7A, 7B and 7C show map 70 comprising a series of horizontal spaced apart lines 71, 71′, 71″, including a centerline 71, a first inner cure path 72 between the two corresponding lines 71′, and a second outer cure path 73 between the two corresponding lines 71″. The cure paths 72 and 73 correspond to the cure paths of a small and large irradiator 30 depicted on the map symbolically as images 301 and 301′ on the right hand side thereof. Vertically disposed and spaced apart along the map 70 are one or more UV label sections 74 each configured to removably receive one or more unexposed UV labels 26, such as by adhesive. As shown in FIG. 7B, UV labels 26 are loaded onto the sections 74 and one more passes of a UV irradiator 30 are made by an operator. The operator can then visualize the color change of the UV labels 26 and compare the color change to the color indications on the legend 75 which is mapped to a key providing an indication of the estimated temperature and/or exposure level for a particular label 26. This allows the user to train in UV irradiator usage to discrete temperature and exposure levels with a visual indication of performance. The horizontal lines and corresponding cure paths 72 and 73 are used as reference guides to assist the user in maintaining a steady path and to ensure that the labels receives adequate coverage and UV application to provide a robust training experience. Thermometer 28 may also be provided for additional testing, measurement, training, and feedback. FIG. 7B is another embodiment of the training aid configured as a map 70 similar to that shown in FIG. 7A except that the legend 75 is provided vertically adjacent to the label section 74 in order to provide a more immediate comparison as to the amount of UV exposure, temperature application and the like. FIG. 7C is yet another embodiment of the map 70 providing more direct instructional information including a center line 71 depicted by an arrow.

The present invention may be configured as a training kit comprising one or more guide maps 70 and one or more strips 21 in a self-contained training unit comprising a binder, folder, clipboard, case or the like. In some embodiments of the kits, the various guide maps are configured to train the user in UV application over cure paths of varying shapes, widths, lengths, temperature requirements, and substrate surfaces. A plurality of strips 21 may be provided in the kit to allow for on demand training on a variety of substrates and objects such that one can quickly and readily hone one's skill in UV curing.

While specific embodiments have been described in detail, those of ordinary skill in the art will appreciate that various modifications and alternatives to such details could be developed in light of the overall teachings of the disclosures. Accordingly, the particular arrangements disclosed are meant to be illustrative only and not limiting of the invention, which is to be given the full breadth of the appended claims, and any and all equivalents thereof.

What is claimed is:

1. An ultra-violet (“UV”) curing training aid comprising:
a UV impervious substrate;
a plurality of UV cured photochromatic labels disposed at predetermined locations on said substrate, said UV cured labels having been exposed with a predetermined dosage of UV radiation and having a predetermined exposure color; and
a plurality of unexposed photochromatic labels disposed at other predetermined locations on said substrate, said unexposed photochromatic labels substantially unexposed with UV radiation and having a predetermined pre-exposure color.

2. The UV curing training aid of claim 1 further comprising a thermometer disposed on said substrate.

3. The UV curing training aid of claim 1, wherein said UV cured photochromatic labels are removably attached to said substrate.

4. The UV curing training aid of claim 1, wherein said unexposed photochromatic labels are removably attached to said substrate.

5. The UV curing training aid of claim 1, wherein the UV cured photochromatic labels or the unexposed photochromatic labels include an adhesive backing.

6. The UV curing training aid of claim 1, wherein the UV cured photochromatic labels or the unexposed photochromatic labels include thereon designations delimiting one or more cure paths.

7. A method of training in ultra-violet (“UV”) curing, comprising:
providing a UV impervious substrate including a plurality of UV cured photochromatic labels having a predetermined exposure color and a plurality of initially-unexposed photochromatic labels having a predetermined pre-exposure color;
providing a UV irradiator including a UV lamp;
passing said UV irradiator over at least one of said initially-unexposed photochromatic labels to cause said initially-unexposed photochromatic labels to change color from said pre-exposure color; and
visually inspecting and analyzing the change of color of said initially-unexposed photochromatic labels.

8. The method of claim 7, further comprising the step of continuing to pass said UV irradiator over said initially-unexposed photochromatic labels until said initially-unexposed photochromatic labels match said exposure color of said UV cured photochromatic labels.

9. The method of claim 7, wherein a thermometer is disposed on said substrate.

10. The method of claim 7, wherein said UV cured photochromatic labels are removably attached to said substrate.

11. The method of claim 7, wherein said initially-unexposed photochromatic labels are removably attached to said substrate.

12. The method of claim 7, wherein the UV cured photochromatic labels or the initially-unexposed photochromatic labels include an adhesive backing.

13. The method of claim 7, wherein the UV cured photochromatic labels or the initially-unexposed photochromatic labels include thereon designations delimiting one or more cure paths.

14. An ultra-violet (“UV”) curing training aid, comprising,
a UV impervious substrate having a series of horizontal spaced apart lines including a centerline, an inner cure path, and a second outer cure path; and one or more UV label sections at least partially overlapping with one of said inner and outer cure paths;
a plurality of initially-unexposed photochromatic labels, said initially-unexposed photochromatic labels substantially unexposed with UV radiation and having a predetermined pre-exposure color; and
wherein each UV label section is configured to removably receive one or more unexposed UV labels.

15. The UV curing training aid of claim 14, wherein the inner and outer cure paths designate and correspond to the cure paths of a small and large UV irradiator, respectively

16. The UV curing training aid of claim 14, further comprising a legend for visualizing a color change of the initially-unexposed photochromatic labels and for comparing said color change to one or more color indications on said legend, said legend mapped to a key providing an indication of an estimated temperature or an estimated UV exposure level of said initially-unexposed photochromatic labels.
